(19) United States
(12) Patent Application Publication
(10) Pub. No.: US 2015/0347527 A1
(43) Pub. Date: Dec. 3, 2015

(54) METHODS AND SYSTEMS FOR PROCESSING AND DISPLAYING STRUCTURED DATA

(71) Applicant: GM GLOBAL TECHNOLOGY OPERATIONS LLC, Detroit, MI (US)

(72) Inventors: AMIR KONIGSBERG, HERZLIYA PITUACH (IL); CLAUDIA V. GOLDMAN-SHENHAR, MEVASSERET ZION (IL)

(73) Assignee: GM GLOBAL TECHNOLOGY OPERATIONS LLC, Detroit, MI (US)

(21) Appl. No.: 14/287,959

(22) Filed: May 27, 2014

(51) Int. Cl. G06F 17/30

(52) U.S. Cl. CPC G06F 17/30554; G06F 17/3053

(57) ABSTRACT

Methods and systems are provided for processing data. In one embodiment, a method comprises: receiving query data that requests a result; performing a query on structured data to determine a plurality or results; determining a relevancy for the plurality of results; and generating graphical user interface data for graphically displaying the plurality of results in a user interface based on the relevancy.

### TECHNICAL FIELD

The technical field generally relates to methods and systems for processing structured data in a particular data environment and for presenting results of the processing on a graphical user interface.

### BACKGROUND

In-vehicle information systems have become commonplace in vehicles such as automobiles, trucks, sport utility vehicles, etc. The information systems typically provide navigation information, entertainment information (e.g., information associated with the radio, CD player, DVD player, etc.), phone information, and other information that may be associated with the vehicle or an application associated with the vehicle. In some instances, a user may use the in-vehicle information system to search for particular information. For example, the user may search navigation information for a particular type of destination at or near a geographic location. The in-vehicle information system typically provides the results in a list format. When a large number of results are provided to the user, the list format can be difficult and time consuming to evaluate while riding in the vehicle. As can be appreciated, this list format can be difficult and time consuming to navigate in any environment and not just the vehicle environment.

Accordingly, it is desirable to provide methods and systems for processing structured data in a particular data environment and for presenting results of the processing on a graphical user interface. In addition, other desirable features and characteristics of the present invention will become apparent from the subsequent detailed description and the appended claims, taken in conjunction with the accompanying drawings and the foregoing technical field and background.

### SUMMARY

Methods and systems are provided for processing data. In one embodiment, a method comprises: receiving query data that requests a result; performing a query on structured data to determine a plurality or results; determining a relevancy for the plurality of results; and generating graphical user interface data for graphically displaying the plurality of results in a user interface based on the relevancy.

In another embodiment, a system comprises a first module, a second module, and a third module. The first module receives query data that requests a result, and that performs a query on structured data to determine a plurality or results. The second module determines a relevancy for the plurality of results. The third module generates graphical user interface data for graphically displaying the plurality of results in a user interface based on the relevancy.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a data processing system that is implemented in a vehicle in accordance with various embodiments;

FIG. 2 is a dataflow diagram illustrating a control module of the data processing system in accordance with various embodiments;

FIGS. 3A and 3B are illustrations of an interactive interface of the data processing stem in accordance with various embodiments; and

FIG. 4 is a flowchart illustrating data processing methods that may be performed by the data processing system of FIG. 1 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

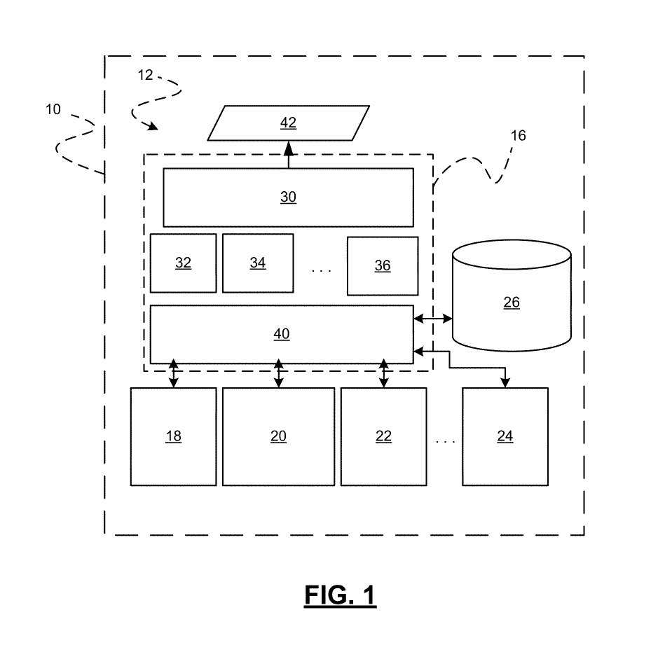

FIG. 1 is a functional block diagram of a vehicle 10 that includes a data processing system 12 in accordance with various embodiments. As can be appreciated, the exemplary vehicle 10 may be an automobile, an aircraft, a spacecraft, a watercraft, a sport utility vehicle, or any other type of vehicle. For exemplary purpose, the environment of the data processing system 12 is provided as the vehicle 10. As can be appreciated, the data processing system 12 may be implemented in any environment having associated structured data and is not limited to the present vehicle example.

Although the figures shown herein depict an example with certain arrangements of elements, additional intervening elements, devices, features, or components may be present in actual embodiments. It should also be understood that FIG. 1 is merely illustrative and may not be drawn to scale.

As shown, the vehicle 10 includes an infotainment system 16 (among other elements not shown) that communicates with one or more vehicle systems 18-24 to provide audio and/or visual entertainment features, with navigation and/or vehicle controls features of the vehicle 10. The vehicle systems can include, but are not limited to, a media system 18, a telecommunications system 20, a navigation system 22, and/or a vehicle feature system 24, such as a heating and cooling system or other system. As can be appreciated, the vehicle systems 18-24 can be implemented as a part of or separate from the infotainment system 16.

Each system 18-24 is associated with structured data. The structured data may be used by the system 18-24 and/or the infotainment system 16 to operate. For example, the structured data for the media system 18 may include artists and songs available to the user. In another example, the structured data for the telecommunications system may include contacts and contact information. In still another example, the structured data for the navigation system 22 may include destination and route information. The structured data is arranged in a searchable format. The structured data may be stored in a data storage device of the respective system and/or in a data storage device of the infotainment system. For exemplary purposes, the structured data is shown in this example to reside in a single data storage device 26 that is associated with and/or managed by the infotainment system 16.

The infotainment system 16 generally includes a display device 30, one or more user input devices 32-36, and a control module 40. The display device 30 may be any display device capable of displaying an interactive interface 42, such as a suitably configured liquid crystal display (LCD), plasma, cathode ray tube (CRT), or heads-up display. The display device 30 displays information (i.e., navigation information, media information, phone information, feature control information, and/or other information) to a user of the infotainment system 16 through an interactive interface 42 that is graphical in nature. The input devices 32-36 may be any input device capable of receiving input from a user when interacting with the interactive interface 42. In various embodiments, the input devices 32-36 may be a part of the display device 30 such as, but not limited to, touch screen sensors, and/or may be separate from the display device 30 such as, a keyboard or keypad, a voice recognition system, a cursor control device, a joystick or knob, or a selection button that is associated with the display device 30.

The control module 40 receives data inputs from the user input devices 32-36 and processes the structured data of the data storage device 26 based on the data processing methods of the present disclosure. For example, the control module 40 receives data input indicating a query of some sort that requests a result. In the provided example, the query may be a request for media information, navigation information, or contact information. The control module 40 determines possible results based on the query and computes a relevancy of the possible results based on various criteria. In various embodiments, the control module 40 generates display data to display the possible results to the user in the interactive interface 42 based on the computed relevancy. In addition to displaying the results, the display data graphically represents the relevancy of the result such that the user can more easily identify and select results that may be more relevant.

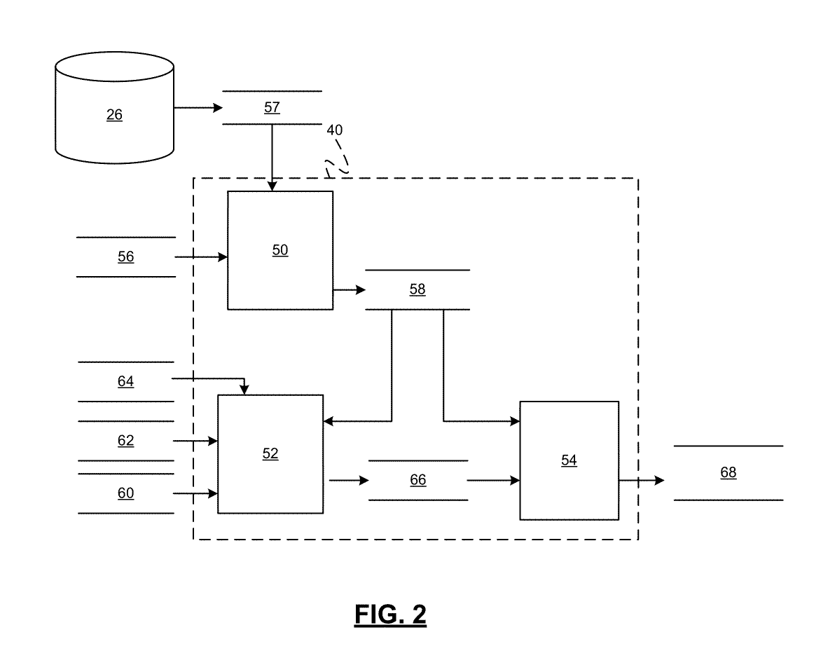

Referring now to FIG. 2 and with continued reference to FIG. 1, a dataflow diagram illustrates the control module 40 in accordance with various embodiments. Various embodiments of the control module 40 according to the present disclosure may include any number of sub-modules. As can be appreciated, the sub-modules shown in FIG. 2 may be combined and/or further partitioned to similarly process structured data based on a query and to generate user interface data. Inputs to the control module 40 may be received from the input devices 32-36, received from other control modules (not shown) of the vehicle 10, and/or determined by other sub-modules (not shown) of the control module 40. In various embodiments, the control module 40 communicates with one or more data storage devices 26 that store structured data, and includes a results determination module 50, a relevancy determination module 52, and an interface data generation module 54.

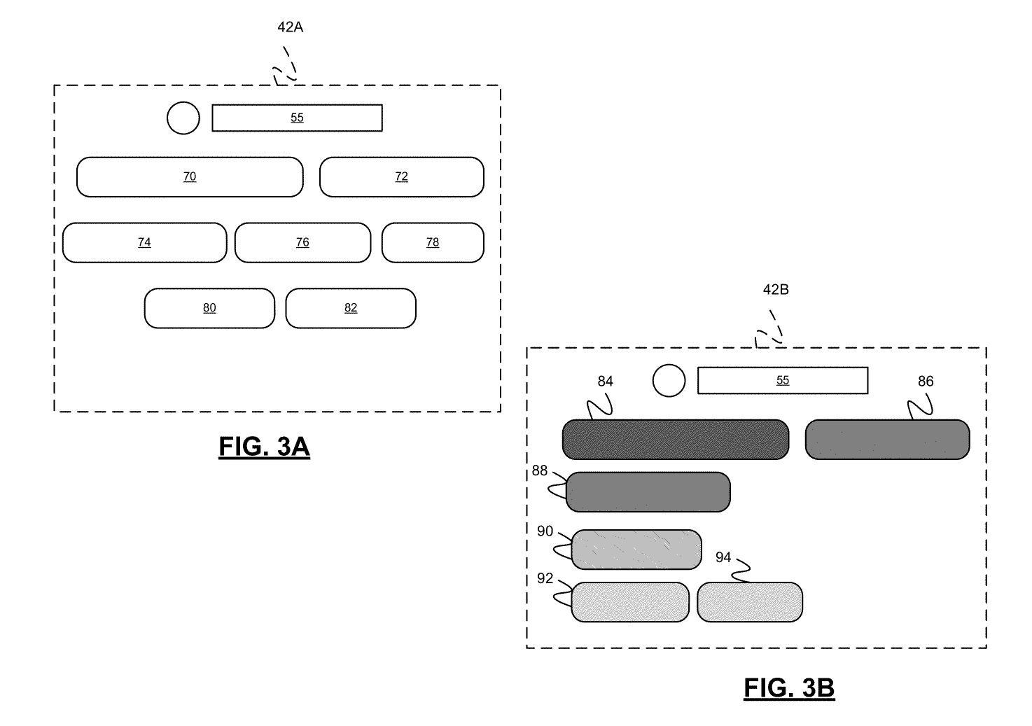

The results determination module 50 receives as input the query data 56. The query data 56 may be generated, for example, based on a user entering a query into a query input box 55 (FIGS. 3A and 3B) of the interactive interface 42 via one or more of the input devices 32-36. The query data 56 may include an indication of a request for a result. The results determination module 50 performs a query on the structured data 57 in the structured data storage device 26 based on the query data 56. The results determination module 50 provides a list of results 58 based on the query. For example, the query data 56 may indicate a request for a destination at or near a particular location and the list of results 58 may include a list of destinations that are at or near the particular location.

The relevancy determination module 52 receives as input the query data 56, the list of results 58, context data 60, history data 62, and user data 64. The context data 60 indicates a context of the query and can be determined from sensors or from other control modules of the vehicle 10. In various embodiments, the context of the query indicates an environmental context associated with the query request and, in this example, may include vehicle conditions (e.g., vehicle speed, vehicle location, vehicle system states, etc.) and/or ambient conditions (e.g., time of day, temperature, season, etc.). The history data 62 includes past queries and/or a performance or results of the queries and, optionally, a context associated with the past queries and/or performance or results. In various embodiments, the history data 62 additionally or alternatively includes data indicating a user's past interactions with the user interface for the same or similar query or result. The user data 64 includes an indication of the user initiating the request or operating the vehicle 10.

Based on the inputs, the relevancy determination module 52 determines a relevancy 66 for each result (or for a subset of results). The relevancy determination module 52 determines the relevancy 66 of a result of the query based on a probability of the result being useful. The relevancy determination module 52 determines the probability of the result being useful given the context of the query, the user initiating the query, the history associated with query and/or result, and the query itself. For example, the relevancy determination module determines the probability using Bayesian Updating, or other known methods of determining a probability.

The interface data generation module 54 receives as input the list of results 58 and the associated relevancies 66. Based on the inputs, the interface data generation module 54 generates graphical user interface data 68. The graphical user interface data 68 includes data for displaying a graphical representation of the results 58 based on the relevancy 66. For example, as shown in the user interface 42A of FIG. 3A, the graphical representation of each result is a geometrical shape (e.g., a rounded square, an oval, or other shape) having on it text or a picture describing the result. As further shown in FIG. 3A, the relevancy is represented by a size of the geometrical shape. For example, the size of the shape can be proportional to the relevancy. As shown, the most relevant result 70 is illustrated with the largest size with lessor relevant results 72-82 having smaller sizes. As further shown in FIG. 3A, the relevancy may be represented by a location of the geometrical shape. For example, the location of the shapes can be based on an identifiability of regions of the interface where the most relevant result 70 is displayed at location that is most identifiable.

In another example, as shown in the user interface 42B of FIG. 3B, the graphical representation of each result is a geometrical shape (e.g., a rounded square, an oval, or other shape) having on it text or a picture describing the result. As further shown in FIG. 3B, the relevancy is represented by a color or shading of the geometrical shape. For example, as shown, the most relevant result 84 is illustrated with a background color and/or a background shading that attracts attention, and the less relevant results 86-94 are illustrated with background colors, and/or background shadings that are less likely to attract attention. In still another example, not shown, the graphical representation of each result is a geometrical shape (e.g., a rounded square, an oval, or other shape) having on it text or a picture describing the result and the font color and/or boldness of the text in the shape can be indicative of the relevancy. For example, the most relevant result may be illustrated with a font color and/or a font boldness that attracts attention, and the less relevant results may be illustrated with font colors, and/or font boldness that are less likely to attract attention.

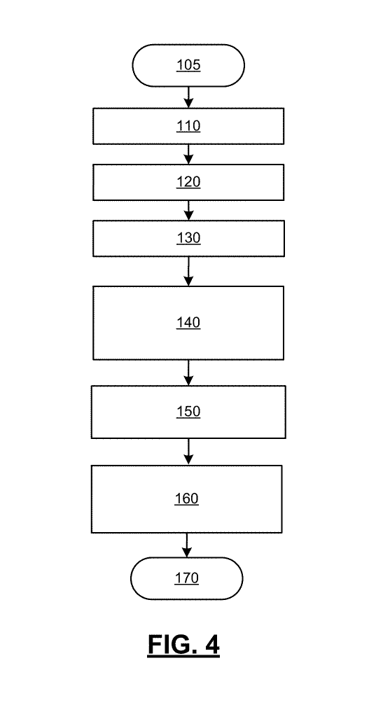

Referring now to FIG. 4 and with continued reference to FIGS. 1-2, flowcharts illustrate data processing methods that may be performed by the infotainment system 16 in accordance with various embodiments. As can be appreciated in light of the disclosure, the order of operation within the methods is not limited to the sequential execution as illustrated in FIG. 4, but may be performed in one or more varying orders as applicable and in accordance with the present disclosure. As can further be appreciated, one or more steps of the methods may be added or removed without altering the spirit of the method.

In one example, the method may begin at 105. The query data 56 is received based on a user entering a query into the interactive interface 42 via one or more of the input devices 32-36 at 110. The list or results 58 are determined based on the structured data 57 in the structured data datastore 26 at 120. The relevancy is determined for each result 58 (or a subset of the results 58) based on the context data 60, the history data 62, the user data 64, and/or the query data 56 at 130. The graphical user interface data 68 for each result 58 (or the subset of the results 58) is determined based on the relevancy. The graphical user interface data 68 is incorporated into the interactive interface 42 at 150; and the interactive interface 42 is displayed at 160 to graphically depict the results according to their relevancy. Thereafter, the method may end at 170.

While at least one exemplary embodiment has been presented in the foregoing detailed description, it should be appreciated that a vast number of variations exist. For example, the data processing methods and systems of the present disclosure can be implemented in any environment having structured data that is searchable, such as, but not limited to, manuals, tutorials, databases (e.g., location based service databases), directories, shopping websites, etc.

Those of skill in the art will appreciate that the various illustrative logical blocks, modules, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of processing data, comprising:
receiving query data that requests a result;
performing a query on structured data to determine a plurality or results;
determining a relevancy for the plurality of results; and
generating graphical user interface data for graphically displaying the plurality of results in a user interface based on the relevancy.

2. The method of claim 1, wherein the determining the relevancy is based on a context of the query.

3. The method of claim 1, wherein the determining the relevancy is based on a history of the query.

4. The method of claim 1, wherein the determining the relevancy is based on a user that initiates the query.

5. The method of claim 1, wherein the determining the relevancy is based on a probability of usefulness of the result.

6. The method of claim 1, wherein the generating the graphical user interface data comprises determining a size of a geometrical shape based on the relevancy and generating the graphical user interface data based on the size of the geometrical shape.

7. The method of claim 1, wherein the generating the graphical user interface data comprises determining a shading of a geometrical shape based on the relevancy and generating the graphical user interface data based on the shading of the geometrical shape.

8. The method of claim 1, wherein the generating the graphical user interface data comprises determining a location of a geometrical shape on the user interface based on the relevancy and generating the graphical user interface data based on the location of the geometrical shape.

9. The method of claim 1, wherein the generating the graphical user interface data comprises determining a font color of text of a geometrical shape on the user interface based on the relevancy and generating the graphical user interface data based on the font color of the font of the geometrical shape.

10. The method of claim 1, wherein the generating the graphical user interface data comprises determining a font boldness of text of a geometrical shape on the user interface based on the relevancy and generating the graphical user interface data based on the font boldness of the font of the geometrical shape.

11. A system for of processing data, comprising:
a first module that receives query data that requests a result, and that performs a query on structured data to determine a plurality or results;
a second module that determines a relevancy for the plurality of results; and
a third module that generates graphical user interface data for graphically displaying the plurality of results in a user interface based on the relevancy.

12. The system of claim 11, wherein the determining the relevancy is based on at least one of a context of the query, a history of the query, and a user that initiates the query.

13. The system of claim 11, wherein the second module determines the relevancy based on a probability of usefulness of the result.

14. The system of claim 11, wherein the third module generates the graphical user interface data by determining at least one of size of a geometrical shape, a shading of the geometrical shape, a location of the geometrical shape, a font color of text of the geometrical shape, and a font boldness of text of the geometrical shape based on the relevancy and by generating the graphical user interface data based on the at least one of the size, the shading, the location, the font color, and the font boldness of the geometrical shape.

15. The system of claim 11, further comprising a data storage device that stores the structured data, wherein the data storage device is associated with at least one of a media system, a telecommunication system, and a navigation system.

16. The system of claim 11, further comprising a data storage device that stores the structured data, wherein the data storage device is associated with a vehicle system.

17. The system of claim 11, wherein the first module, the second module, and the third module are part of a control module of an infotainment system.

18. The system of claim 17, wherein the infotainment system is of a vehicle.

19. A computer program product for processing data, the computer program product, comprising:
a non-transitory computer readable medium that stores instructions for processing data according to a method comprising the steps of:
receiving query data that requests a result;
performing a query on structured data to determine a plurality or results;
determining a relevancy for the plurality of results; and
generating graphical user interface data for graphically displaying the plurality of results in a user interface based on the relevancy.
